(19) United States
(12) Patent Application Publication
(10) Pub. No.: US 2021/0404700 A1
(43) Pub. Date: Dec. 30, 2021

(54) Vent Cover Apparatus

(71) Applicant: Evaristo Montoya, Los Lunas, NM (US)

(72) Inventor: Evaristo Montoya, Los Lunas, NM (US)

(21) Appl. No.: 16/917,158

(22) Filed: Jun. 30, 2020

(51) Int. Cl. F24F 13/20

(52) U.S. Cl. CPC F24F 13/20; F24F 2221/44

(57) ABSTRACT

A vent cover apparatus for protecting vents, air conditioners, and skylights includes a cover body having a body front side, a body back side, a body left side, a body right side, a body top side, and an open body bottom side. The body bottom side is configured to receive a vent, an air conditioner, or a skylight on a roof of a recreational vehicle or a building. The cover body is rigid and allows for full air flow through the cover body. A plurality of mounting braces is coupled to the cover body. Each mounting brace is coupled adjacent the body bottom side and configured to engage the roof of the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cover devices and more particularly pertains to a new vent cover device for protecting vents, air conditioners, and skylights.

### (2) Description of Related Art Including Information Disclosed Under 37 CFR 1.97 and 1.98

The prior art relates to cover devices to protect vehicles and roofs. Some existing devices cover a roof in its entirety rather than accommodating just a vent, air conditioner, or skylight. Other devices are not breathable on all sides and are not easily installed on a vehicle roof.

### BRIEF SUMMARY OF THE INVENTION

An embodiment of the disclosure meets the needs presented above by generally comprising a cover body having a body front side, a body back side, a body left side, a body right side, a body top side, and an open body bottom side. The body bottom side is configured to receive a vent, an air conditioner, or a skylight on a roof of a recreational vehicle or a building. The cover body is rigid and allows for full air flow through the cover body. A plurality of mounting braces is coupled to the cover body. Each mounting brace is coupled adjacent the body bottom side and configured to engage the roof of the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a vent cover apparatus according to an embodiment of the disclosure.

FIG. 2 is a bottom plan view of an embodiment of the disclosure.

FIG. 3 is a side elevation view of an embodiment of the disclosure.

FIG. 4 is a front elevation view of an embodiment of the disclosure.

FIG. 5 is an in-use view of an embodiment of the disclosure.

### DETAILED DESCRIPTION OF THE INVENTION

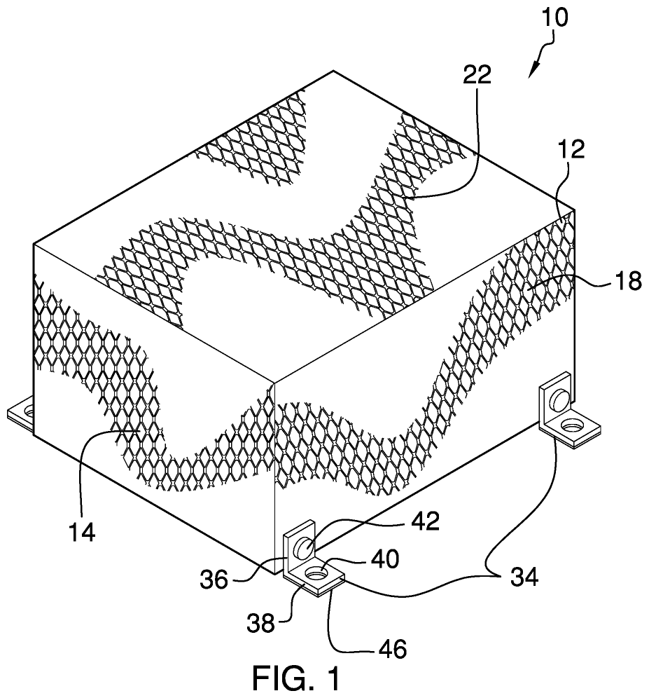

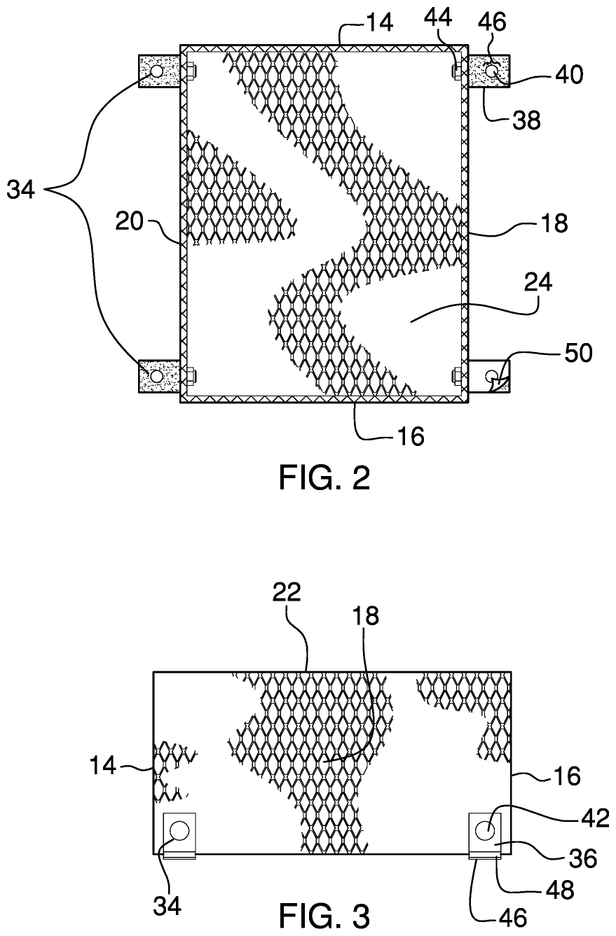

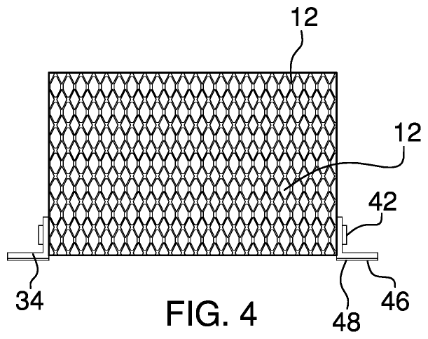

With reference now to the drawings, and in particular to FIGS. 1 through 5 thereof, a new vent cover device embodying the principles and concepts of an embodiment of the disclosure and generally designated by the reference numeral 10 will be described.

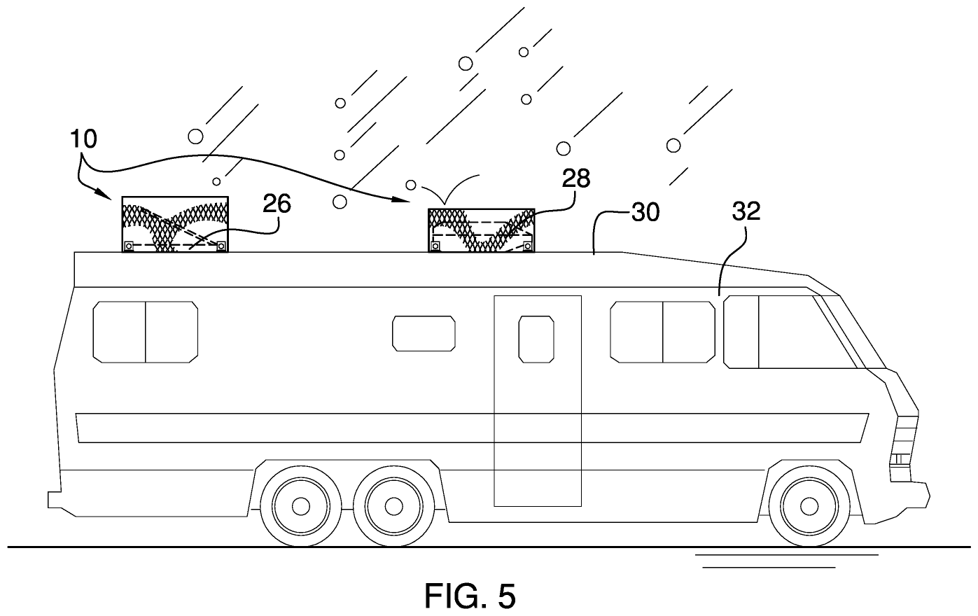

As best illustrated in FIGS. 1 through 5, the vent cover apparatus 10 generally comprises a cover body 12 having a body front side 14, a body back side 16, a body left side 18, a body right side 20, a body top side 22, and an open body bottom side 24. The body bottom side 24 is configured to receive a vent 26, an air conditioner 28, or a skylight on a roof 30 of a recreational vehicle 32 or a building. The cover body 12 is rigid and allows for full air flow through the cover body 12 while providing protection against damage from the elements or other physical contact. The height of the cover body 12 may accommodate a range of movement in the vent 26 as shown in FIG. 5. The cover body 12 may be wire mesh, rigid screen, perforated polymer or other rigid and vented material.

A plurality of mounting braces 34 is coupled to the cover body 12. The plurality of mounting braces 34 may comprise two mounting braces 34 coupled to the body left side 18 and two mounting braces 34 coupled to the body right side 20. Each mounting brace 34 is coupled adjacent the body bottom side 24 and is configured to engage the roof 30 of the vehicle or building. Each mounting brace 34 may be L-shaped with a vertical portion 36 coupled to the cover body 12 and a horizontal portion 38 extending parallel to the body bottom side 24. The horizontal portion 38 has a mounting aperture 40 extending therethrough to receive mounting hardware. The vertical portion 36 may have an attachment bolt 42 extending through the cover body 12 and an attachment nut 44 selectively engaged with the attachment bolt 42. The vertical portion 36 may alternative be permanently fixed or adhered to the cover body 12.

A plurality of adhesive layers 46 is coupled to the plurality of mounting braces 34. Each adhesive layer 46 is coupled to an underside 48 of the horizontal portion 38 of each mounting brace. The adhesive layer 46 may uniformly cover an entirety of the underside 48 excepting the mounting aperture 40. Each adhesive layer 46 is also a sealant to ensure water cannot pass through to damage the mounting hardware or enter the roof 30. Each adhesive layer 46 may also have a removable cover 50 to prevent loss of adhesion prior to installation.

In use, the cover body 12 is selected to appropriately accommodate the desired object and its required range of motion. The removable cover 50 is peeled from each adhesive layer 46 and engaged with the roof 30 surrounding the covered object. Mounting hardware is then installed through the roof 30 to further secure the apparatus 10 in place.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vent cover apparatus comprising:
a cover body, the cover body having a body front side, a body back side, a body left side, a body right side, a body top side, and an open body bottom side, the body bottom side being configured to receive a vent, an air conditioner, or a skylight on a roof of a recreational vehicle or a building, the cover body being rigid and allowing for full air flow through the cover body; and
a plurality of mounting braces coupled to the cover body, each mounting brace being coupled adjacent the body bottom side and being configured to engage the roof of the vehicle.

2. The vent cover apparatus of claim 1 further comprising each mounting brace of the plurality of mounting braces having a vertical portion coupled to the cover body and a horizontal portion extending parallel to the body bottom side.

3. The vent cover apparatus of claim 2 further comprising the horizontal portion having a mounting aperture extending therethrough to receive mounting hardware.

4. The vent cover apparatus of claim 2 further comprising a plurality of adhesive layers coupled to the plurality of mounting braces, each adhesive layer being coupled to an underside of the horizontal portion of each mounting brace, each adhesive layer also being a sealant.

5. The vent cover apparatus of claim 4 further comprising each adhesive layer having a removable cover.

6. The vent cover apparatus of claim 2 further comprising the vertical portion having an attachment bolt extending through the cover body and an attachment nut selectively engaged with the attachment bolt.

7. The vent cover apparatus of claim 1 further comprising the cover body being wire mesh.

8. The vent cover apparatus of claim 1 further comprising the plurality of mounting braces comprising two mounting braces coupled to the body left side and two mounting braces coupled to the body right side.

9. A vent cover apparatus comprising:
a cover body, the cover body having a body front side, a body back side, a body left side, a body right side, a body top side, and an open body bottom side, the body bottom side being configured to receive a vent, an air conditioner, or a skylight on a roof of a recreational vehicle or a building, the cover body being rigid and allowing for full air flow through the cover body, the cover body being wire mesh;
a plurality of mounting braces coupled to the cover body, the plurality of mounting braces comprising two mounting braces coupled to the body left side and two mounting braces coupled to the body right side, each mounting brace being coupled adjacent the body bottom side and being configured to engage the roof of the vehicle, each mounting brace having a vertical portion coupled to the cover body and a horizontal portion extending parallel to the body bottom side, the horizontal portion having a mounting aperture extending therethrough to receive mounting hardware, the vertical portion having an attachment bolt extending through the cover body and an attachment nut selectively engaged with the attachment bolt; and
a plurality of adhesive layers coupled to the plurality of mounting braces, each adhesive layer being coupled to an underside of the horizontal portion of each mounting brace, each adhesive layer also being a sealant, each adhesive layer having a removable cover.
